(19) United States
(12) Patent Application Publication
(10) Pub. No.: US 2009/0122139 A1
(43) Pub. Date: May 14, 2009

(54) Display System for a Motor Vehicle

(76) Inventors: Reinfried Grimmel, Friedberg (DE); Manfred Hahl, Muhlheim (DE); Ulrich Roskoni, Wollstadt (DE); Norbert Schmidt, Eppstein (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/063,551

(22) PCT Filed: Jul. 25, 2006
(86) PCT No.: PCT/EP2006/064642

§ 371 Date: Oct. 2, 2008

(30) Foreign Application Priority Data
Aug. 18, 2005 (DE) 10 2005 039 481.7
Feb. 10, 2006 (DE) 10 2006 006 290.6

(51) Int. Cl. H04N 7/18

(52) U.S. Cl. 348/148; 348/E07.085

(57) ABSTRACT

In a display system for a motor vehicle (11), an image detecting device captures an image of the surroundings of the motor vehicle (11), the image is converted into image data by an image generating device (2), and the image data can be represented as a virtual image in the driver's (7) field of vision via a beam deflection unit (5) and a combiner (6) that features variable transmission.

### CROSS-REFERENCE TO RELATED APPLICATIONS

This application is a U.S. national stage application of International Application No. PCT/EP2006/064642 filed Jul. 25, 2006, which designates the United States of America, and claims priority to German application number 10 2005 039 481.7 filed Aug. 18, 2005 and German application number 10 2006 006 290.6 filed Feb. 10, 2006, the contents of which are hereby incorporated by reference in their entirety.

### TECHNICAL FIELD

The invention relates to a display system for a motor vehicle, in which an image recording unit captures the image of the surroundings of the motor vehicle, which image is converted by an image generating device into image information which can be displayed as a virtual image in the field of vision of the driver by means of a beam deflection unit and a combiner.

### BACKGROUND

Driver assistance systems nowadays need to feed the data directly onto the vehicle's windshields for the driver so that the image generating unit can be located in an acceptable position in the vehicle even when there is a steep windshield, such as are present, for example, in a truck or a bus.

Systems which are known from the prior art in which infrared cameras are provided as image recording units and the image which is recorded by the infrared camera is displayed in a virtual fashion in the field of vision of the driver of the motor vehicle by means of a head-up display. In such a context the head-up display has a combiner which is located above the driver's straight-ahead view, between the driver and the windshield. This combiner has fixed transmission and reflection, making it possible to display an image.

One of the greatest difficulties to be overcome when displaying by means of a head-up display is always to ensure that the displayed image can be perceived well under all conceivable extraneous light conditions.

### SUMMARY

According to an embodiment, a display system for a motor vehicle may comprise an image recording device for capturing an image of the surroundings of a motor vehicle, wherein the image is converted by an image generating device into image information which is displayed as a virtual image in the field of vision of the driver by means of a beam deflection unit and a combiner, wherein the combiner has variable transmission, and wherein the combiner is a component of a sun visor of the motor vehicle.

Such a system may permit good readability under all extraneous light conditions.

According to a further embodiment, the combiner may be embodied as a sun visor. According to a further embodiment, the transmission of the combiner can be adjusted automatically.

According to a further embodiment, the combiner may have photochromic substances. According to a further embodiment, the combiner may be fabricated on the basis of LCDs. According to a further embodiment, the combiner may be connected to a control unit which sets the transmission of the combiner as a function of the external brightness. According to a further embodiment, the transmission of the combiner can be varied manually. According to a further embodiment, at least one film which has a fixed transmission may be attached to the combiner, which film can be stretched over at least part of the combiner.

### BRIEF DESCRIPTION OF THE DRAWINGS

The invention permits numerous embodiments. One of these will be explained in more detail with reference to the figures illustrated in the drawing, in which:

FIG. 1: is an illustration of a head-up display,

FIG. 2: shows an arrangement of the head-up display in a truck, and

FIG. 3: shows an arrangement of the combiner.

### DETAILED DESCRIPTION

According to an embodiment, the combiner may have a variable transmission. Owing to this variable transmission, the readability of the display is reliably ensured given any degree of external brightness, as a result of which the head-up display can be configured both for operation during the day and for operation at night.

According to another embodiment, the transmission of the combiner can be adjusted automatically.

For this purpose, the combiner can have photochromic substances which change the transmission of the combiner as a function of the brightness.

In another embodiment, the combiner is fabricated on the basis of LCDs. In this context, the combiner is connected to a control unit which sets the transmission of the combiner as a function of the external brightness. As a result, the combiner can be darkened during the day, and the possibility of inputting data into the image is provided. At night, the actuated combiner would give a virtually transparent effect and also serve for image projection, for example for the “night vision” functionality.

In another advantageous embodiment, the transmission of the combiner can be varied manually. For this purpose, at least one film which has a fixed transmission is attached to the combiner, which film can be stretched over at least part of the combiner.

In another embodiment, the combiner is a component of a sun visor of the vehicle. The use of a delimited region of the sun visor as a virtual display medium makes it possible here simultaneously to maintain the effect of the sun visor as a protection against the sun and/or dazzle.

The combiner itself can advantageously be embodied as a sun visor. The external brightness which is visible to the driver is reduced in the display area by reducing the transmission of the combiner. This results in a low light requirement for the display which is reflected into position. This makes it possible to use head-up displays with a small degree of magnification and large displays for day-time operation.

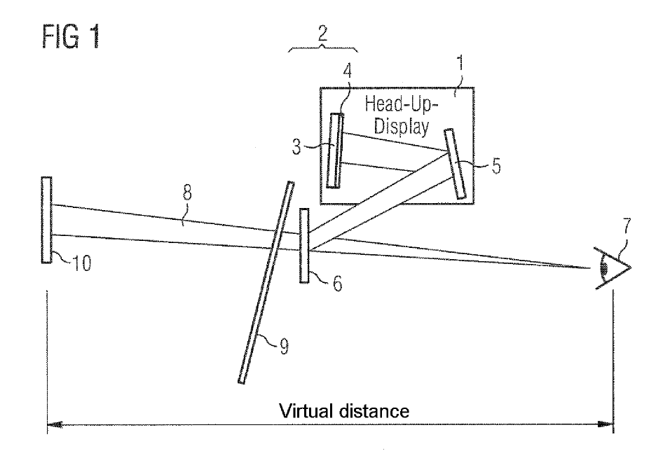

FIG. 1 shows a head-up display 1 such as is customarily used in vehicles. It is composed of an image generating device 2 which is composed of a lighting source 3 and a display 4 which is arranged directly in front of the latter and illuminates it. The image which is to be displayed and which is generated by the image generating unit 2 is imaged on a combiner 6 by a mirror 5 which is arranged in the beam path. The driver 7 looks through the combiner 6 and the windshield 9 of the motor vehicle by means of the beam path 8 at a virtual image 10 which appears to be generated in front of the windshield 9.

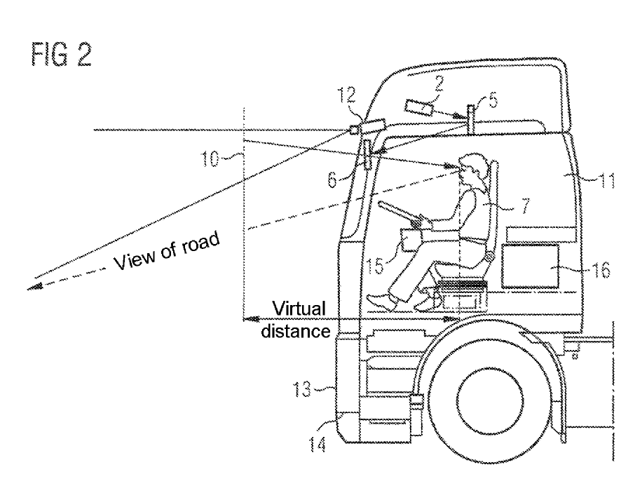

Such a head-up display 1 which is installed in a truck 11 is illustrated in FIG. 2. In addition to the head-up display 1, an infrared camera 12, which records the surroundings in front of the motor vehicle 11, is arranged above the driver's work station. In order to illuminate these surroundings, infrared lights 13 are attached to the radiator grille 14 of the motor vehicle 11.

The combiner 6, in the form of a movable glass pane, is arranged at the position of the otherwise customary sun visor in the motor vehicle 11 and at the same time performs the function of this sun visor. The image 10 which is built up in a virtual fashion in front of the vehicle is viewed by the driver 7 through the combiner 6. Furthermore, a secondary display unit 15 is also provided in the vehicle 11, the display unit 15, the head-up display 1 and the infrared camera 12 being connected to a control unit 16 which controls, inter alia, the display of the virtual image 10.

The infrared camera 12 is therefore preferably used at night or in poor weather conditions so that the virtual image 10 is used to provide the driver 7 with information about the road which he cannot himself perceive with the naked eye, and this significantly increases safety. For this purpose, the images which are captured by the infrared camera 12 are passed on to the image generating device 4 of the head-up display 1 by the control unit 16 and the image which is generated by the image generating device is displayed as a virtual image 10, as described.

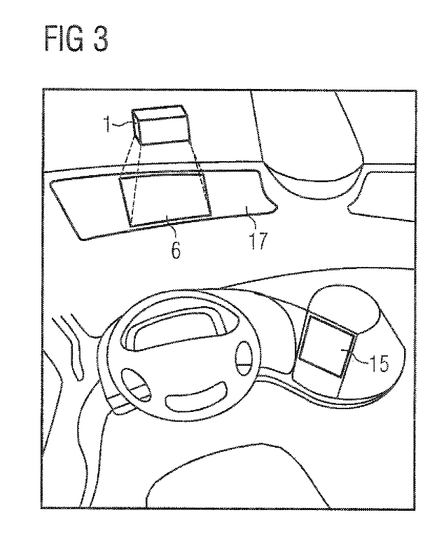

FIG. 3 shows the combiner 6 which is part of the sun visor 17 of the motor vehicle 11. The head-up display 1 is mounted here above the combiner 6 and is therefore located above the straight ahead view of the driver 7.

The combiner 6 is also connected to the control unit 16. This control unit 16 controls the transmission of the combiner 6 as a function of the external brightness which is detected with a brightness sensor (not illustrated further). Decreasing the transmission of the combiner 6 reduces the external brightness visible to the driver in the display area. This results in a low light requirement for the display which is reflected into position.

This makes the use of head-up displays with a low degree of magnification and large displays possible for the first time for operation during the day. Owing to the control of the transmission of the combiner 6 by means of the control unit 16 it is possible for darkening to be carried out during the day, with the effect of a sun visor 17. Furthermore, there is, however, also the possibility of additionally inputting image data during the day. At night, varied actuation of the combiner 6 would have the effect of making the latter virtually transparent and would also be beneficial for the projection of images. With the arrangement according to an embodiment the transmission is preferably controlled outside the primary field of vision of the driver 7 in order to be able to meet legal requirements which do not permit the transmission in the primary field of vision of the driver 7 to be reduced below a certain limit.

What is claimed is:

1. A display system for a motor vehicle comprising an image recording device for capturing an image of the surroundings of a motor vehicle, wherein the image is converted by an image generating device into image information which is displayed as a virtual image in the field of vision of the driver by means of a beam deflection unit and a combiner, wherein the combiner has variable transmission, and wherein the combiner is a component of a sun visor of the motor vehicle.

2. The display system according to claim 1, wherein the combiner is embodied as a sun visor.

3. The display system according to claim 1, wherein the transmission of the combiner can be adjusted automatically.

4. The display system according to claim 3, wherein the combiner has photochromic substances.

5. The display system according to claim 3, wherein the combiner is fabricated on the basis of LCDs.

6. The display system according to claim 4, wherein the combiner is connected to a control unit which sets the transmission of the combiner as a function of the external brightness.

7. The display system according to claim 1, wherein the transmission of the combiner can be varied manually.

8. The display system according to claim 1, wherein at least one film which has a fixed transmission is attached to the combiner, which film can be stretched over at least part of the combiner.

9. A display system for a motor vehicle comprising:
an image recording device for capturing an image of the surroundings of a motor vehicle,
an image generating device for converting the captured image into image information;
a beam deflection unit deflecting said image information received from said image generating device; and
a combiner for combining said deflected image information with a field of view, wherein the combiner has variable transmission and is a component of a sun visor of the motor vehicle.

10. The display system according to claim 9, wherein the combiner is embodied as a sun visor.

11. The display system according to claim 9, wherein the transmission of the combiner can be adjusted automatically.

12. The display system according to claim 11, wherein the combiner has photochromic substances.

13. The display system according to claim 11, wherein the combiner is fabricated on the basis of LCDs.

14. The display system according to claim 12, wherein the combiner is connected to a control unit which sets the transmission of the combiner as a function of the external brightness.

15. The display system according to claim 9, wherein the transmission of the combiner can be varied manually.

16. The display system according to claim 9, wherein at least one film which has a fixed transmission is attached to the combiner, which film can be stretched over at least part of the combiner.

17. A method of operating a display system for a motor vehicle comprising the steps of:
capturing an image of the surroundings of a motor vehicle,
converting the image by an image generating device into image information
displaying the image information as a virtual image in the field of vision of the driver by means of a beam deflection unit and a combiner, wherein the combiner has variable transmission and is a component of a sun visor of the motor vehicle.

18. The method according to claim 17, further comprising the step of adjusting the transmission of the combiner automatically.

19. The method according to claim 17, further comprising the step of varying the transmission of the combiner manually.

20. The method according to claim 17, further comprising the step of attaching at least one film which has a fixed transmission to the combiner, which film can be stretched over at least part of the combiner.
